(19) United States
(12) Patent Application Publication
(10) Pub. No.: US 2021/0132417 A1
(43) Pub. Date: May 6, 2021

(54) Smart Glasses with Eye Protection Function

(71) Applicant: China Jiliang University, Hangzhou City (CN)

(72) Inventors: Huaizhou JIN, Hangzhou City (CN); Shangzhong JIN, Hangzhou City (CN); Yifan Li, Hangzhou City (CN); Xueli Lin, Hangzhou City (CN); Xuecheng Zhang, Hangzhou City (CN); Hangbin Tan, Hangzhou City (CN); Fei Zhang, Hangzhou City (CN)

(73) Assignee: China Jiliang University, Hangzhou City (CN)

(21) Appl. No.: 17/088,783

(22) Filed: Nov. 4, 2020

(30) Foreign Application Priority Data
Nov. 4, 2019 (CN) 201911063710.8

(51) Int. Cl. G02C 7/10; G02C 11/00; G02C 7/08

(52) U.S. Cl. CPC G02C 7/104; G02C 7/085; G02C 11/10

(57) ABSTRACT

Smart glasses with an eye protection function comprise an adjustable focus liquid lens assembly and a drive mechanism. The lens assembly comprises a first lens, a second lens, and a transparent liquid-filled flexible film sandwiched between the first lens and the second lens. The focal length of the lens assembly is determined by the first lens, the second lens, and the flexible film together. The focal length of the flexible film changes as a thickness of the flexible film changes. The drive mechanism is configured to drive the flexible film to deform and thus enable the thickness of the flexible film to be changed such that the focal length of the lens assembly is switched between the first focal length and the second focal length. The glasses enable a user wearing it to blink his or her eyes unconsciously, thereby overcoming the drawback of prior art, and enhancing user experience.

### TECHNICAL FIELD

The present disclosure relates to the fields of smart glasses and eye or eyesight protection, and in particular, to self-adjustable smart glasses with an eye protection function.

### BACKGROUND

With continuous development of high technologies, electronic products have become an integral part of people's lives and work. While the high-tech electronic products bring us convenience, they present other problems. For example, the overall myopia rate is continuously increasing because of our heavy use of computers, smart phones, and the like. When focusing on a screen over a long period of time, blinking frequency is likely to drop. This may induce eye problems, such as xerophthalmia.

Smart glasses are a kind of electronic product that users wear on their heads. A user can utilize the smart glasses to realize real-time video communications, online dynamic games, audio visual interaction, information consultation, etc. However, wearing the smart glasses for a long time will cause user eye fatigue. If eye fatigue cannot be well relieved during use of the smart glasses, further damage may be caused to the user's eyes.

Most of existing patents propose an active intervention to alert the user, for example, by using sound, light, or vibration. However, if, for example, a user is watching a movie on a computer and then light generated from the glasses is suddenly irradiated to his or her eyes, the user's movie experience will be degraded. For another example, if a user is playing a game while wearing smart glasses and then the glasses vibrate suddenly and strongly to remind him or her to rest his or her eyes, the user will be annoyed and will choose not to wear such glasses again.

Therefore, if the user can be enabled to blink his or her eyes unconsciously while wearing smart glasses, the user experience of the glasses will be greatly enhanced and such glasses will be highly competitive on the market.

### SUMMARY

In view of the above, an objective of the present disclosure is to provide a pair of smart glasses with an eye protection function, which can enable a user wearing the glasses to blink his or her eyes unconsciously when his or her eye blink frequency is too low, thereby overcoming the drawback of the prior art, enhancing the user experience and preserving visual health of the user.

The glasses according to the present disclosure is adjustable in focal length when the eyes of a user feel fatigue and can provide a blurred vision for the user of the glasses, so that the user will blink his or her eyes unconsciously. The glasses of the disclosure can have a first focal length, which enables a clear vision to be provided to a user of the glasses, and a second focal length, which is different from the first focal length and enables a blurred vision to be provided to a user of the glasses. The pair of glasses comprises an adjustable focus liquid lens assembly and a drive mechanism. The lens assembly comprises a first lens, a second lens, and a transparent liquid-filled flexible film sandwiched between the first lens and the second lens. The focal length of the lens assembly is determined by the first lens, the second lens, and the flexible film together. The focal length of the flexible film changes as a thickness of the flexible film changes. The drive mechanism is configured to drive the flexible film to deform and thus enable the thickness of the flexible film to be changed such that the focal length of the lens assembly is switched between the first focal length and the second focal length.

Preferably, the first lens may be one of a lens for myopia, a lens for presbyopia, and a plano lens that has no visual correcting power. Preferably, the second lens may be a plano lens. Preferably, the flexible film may be attached to the second lens.

Preferably, the drive mechanism may comprise a piezoelectric ceramic element configured to act on the flexible film, and a drive circuit configured to provide a driving voltage to the piezoelectric ceramic element such that the piezoelectric ceramic element is deformed under the action of the driving voltage and the flexible film is caused to change in thickness, allowing the focal length of the lens assembly to be switched between the first focal length and the second focal length.

Preferably, the drive mechanism may further comprise a film holder, configured to hold one end of the flexible film. In such an embodiment, the piezoelectric ceramic element may be configured to directly cover the film holder, so that the deformation of the piezoelectric ceramic element can cause displacement of the film holder. In the case that the film holder is displaced, the flexible film will be drawn by the film holder to deform, thereby allowing the lens assembly to be switched between the first focal length and the second focal length.

Preferably, both the piezoelectric ceramic element and the film holder may be disposed in a frame of the glasses.

Preferably, the first focal length may be a focal length provided by the lens assembly when the driving voltage is zero, and the second focal length may be a focal length provided by the lens assembly after deformation of the flexible film under the condition that the driving voltage is not zero.

Preferably, the glasses of the present disclosure may further comprise a power supply module for electrically connecting to the drive mechanism and configured to supply power to the drive mechanism and the entire glasses.

Preferably, the glasses may further comprise a blink control device. The blink control device may comprise a blink detection unit configured to detect blinking behavior of a user and calculate a blinking frequency, a comparison unit configured to compare the blinking frequency detected by the blink detection unit with a preset threshold and transmit a comparison result to a control unit, and the control unit, configured to, when it is determined that the blinking frequency is lower than the preset threshold, send a focus adjustment control signal to the drive mechanism.

Preferably, the glasses may further comprise a delay module, which is configured to delay the focus adjustment control signal for a first delay period such that when the drive mechanism receives the focus adjustment control signal, the lens assembly is caused to be switched from the first focal length to the second focal length after the first delay period.

Preferably, the delay module may be further configured to provide a delay of a second delay period such that the lens assembly is caused to be switched back to the first focal length from the second focal length after the second delay period.

The glasses of the present disclosure have several advantages.

The glasses of the disclosure can provide a blurred vision for a user wearing the glasses by varying the focal length via the lens assembly, and the user will be tricked into perceiving his or her eyesight as declined due to eye fatigue and then blink eyes unconsciously. In this way, the user' eyes can be protected without disturbing his or her viewing experience.

The lens assembly of the disclosure may be adapted to requirements of different users, since the first lens of the lens assembly can be customized to user requirements, and in particular can be made as a lens for myopia, a lens for presbyopia, or a plano lens that has no visual correcting power. Moreover, the piezoelectric ceramic element of the drive mechanism of the glasses is configured to be electrically driven to be displaced, so as to cause a change of the flexible film in shape and thus of the focal length, thereby realizing an automatic focus adjustment function of the glasses.

Finally, according to embodiments of the disclosure, a piezoelectric ceramic element is utilized to cause a change in the shape of a liquid-filled flexible film and then to provide adjustable focus for the glasses. In this way, the size and weight of the focus adjustment portion can be reduced, so that it can be adapted to the requirements of the glasses.

### BRIEF DESCRIPTION OF THE DRAWINGS

FIG. 1 is a schematic view of a pair of smart glasses according to an embodiment of the disclosure;

FIG. 2 is a schematic view showing connection among modules in the glasses, according to an embodiment of the disclosure; and

FIG. 3 is a schematic partial cross sectional view of a focus adjustment drive mechanism according to an embodiment of the disclosure.

### DETAILED DESCRIPTION

Embodiments of the present disclosure will now be described in detail with reference to the drawings. It is to be understood, however, that the disclosure is not limited to these example embodiments. Any functionally equivalent structures and methods conceived by those skilled in the art based on the described embodiments should fall within the scope of the disclosure.

As stated above in the background, for current eyesight or eye protection technologies utilized by the electronic products, an active intervention is typically performed when eyes of a user using an electronic product feel fatigue, to remind the user to rest his or her eyes. However, regardless of whether the active intervention is performed as a voice reminder or a visual distraction, the user experience will be degraded. As an example, if a user has been watching a movie on a mobile phone for a long time, a traditional eye protection technology may propose either a pop-up box or a voice reminder to remind the user to have a rest. When the user is interrupted by such a reminder during a movie highlight, he or she will be annoyed. Bad user experience is thus caused.

Therefore, the present disclosure provides a pair of smart glasses with an eye protection function, which is adjustable in focal length when eyes of a user feel fatigue and can provide a blurred vision to the user, so that the user will be tricked into perceiving his or her eyesight as declined and will then blink eyes unconsciously. With this pair of smart glasses, the user's eye can be protected. The glasses of the disclosure can have a first focal length and a second focal length different from the first focal length. The first focal length enables a clear vision to be provided to a user, and the second focal length enables a blurred vision to be provided to a user. The pair of glasses is configured to be switched between the first focal length and the second focal length when a monitored blinking frequency of the user meets a predetermined condition, so as to make the user blink his or her eyes unconsciously.

Embodiments of the present disclosure will be described in further detail below with reference to the drawings.

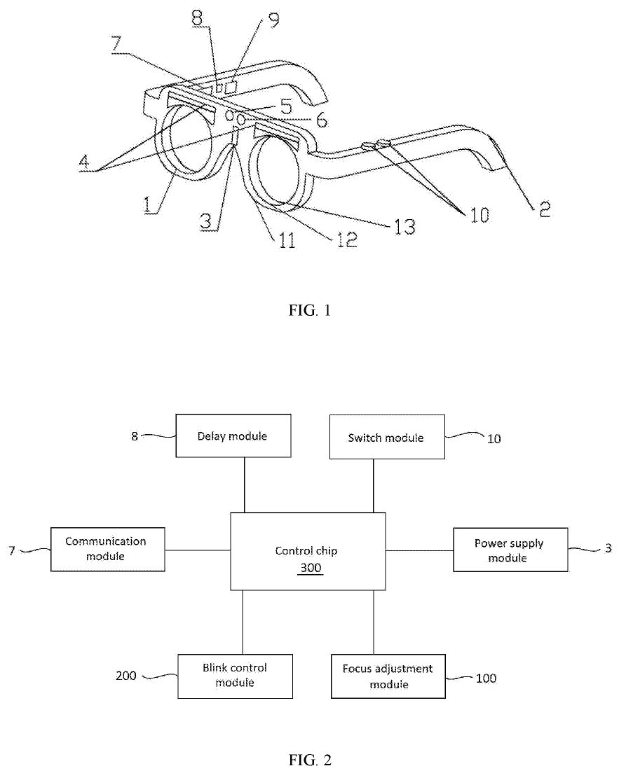

Referring to FIGS. 1 to 3, the glasses of the disclosure comprise a glasses body 100 and a blink control device 200 configured to control the glasses.

The glasses body 100 comprises an adjustable focus liquid lens assembly 1, a frame 2, and a drive mechanism 4. The lens assembly 1 comprises a first lens 11, a second lens 13, and a liquid-filled flexible film 12 sandwiched between the first lens 11 and the second lens 13. In a particular embodiment, the first lens 11 may be one of a lens for myopia, a lens for presbyopia, and a plano lens that has no visual correcting power, and the second lens 13 may be a plano lens. The flexible film 12 may be attached to the second lens 13. A focal length of the flexible film 12 can change as a thickness of the film changes. Since a total focal length of the lens assembly 1 is determined by the first lens 11, the second lens 13, and the flexible film 12 together, the total focal length of the lens assembly 1 changes as the focal length of the flexible film 12 changes. As such, the main objective of the disclosure is realized.

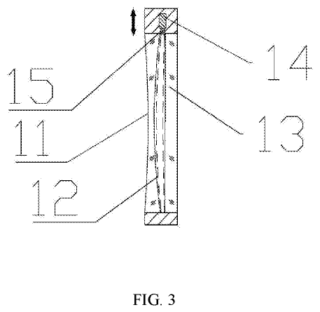

Referring to FIG. 3, the drive mechanism 4 may comprise a piezoelectric ceramic element 14 and a drive circuit (not shown). The piezoelectric ceramic element 14 may be configured to act on the flexible film 12. The drive circuit may be configured to provide a driving voltage to the piezoelectric ceramic element 14, such that the piezoelectric ceramic element 14 can be deformed under the action of the driving voltage. The deformation of the piezoelectric ceramic element 14 may cause the flexible film 12 to be drawn and thus to be changed in thickness. In this way, the lens assembly 1 can be allowed to be switched between the first focal length and the second focal length. Therefore, the first focal length may be a focal length provided by the lens assembly when the driving voltage is zero, and the second focal length may be a focal length provided by the lens assembly after deformation of the flexible film under the condition that the driving voltage is not zero.

In an embodiment, the drive mechanism 4 may further comprise a film holder 15. The film holder 15 may be configured to hold one end of the flexible film 12. In such an embodiment, the piezoelectric ceramic element 14 may be configured to directly cover the film holder 15, so that the deformation of the piezoelectric ceramic element 14 can cause displacement of the film holder 15. When the film holder 15 is displaced, the flexible film 12 can be drawn by the film holder 15 to deform, thereby allowing the lens assembly 1 to be switched between the first focal length and the second focal length.

The piezoelectric ceramic element 14 and the film holder 15 may be disposed in the frame 2 of the glasses.

In another embodiment, the change of the thickness of the flexible film 12 may be done by pressing the first lens 11 and the second lens 13. The pressing may be achieved by deforming the piezoelectric ceramic element, which is disposed in the frame 2 housing the first lens 11 and the second lens 13. In turn, the flexible film 12 may be pressed by the first and second lenses 11, 13, so that the thickness of the film 12 and thus the length focal thereof can be changed.

In other embodiments, the piezoelectric ceramic element may be replaced by a micro-motor, configured to cause the flexible film to be drawn or the first and second lenses to be pressed.

The frame 2 may further comprise a power supply module 3, which is configured to be electrically connected to the drive mechanism 4 for supplying power to the drive mechanism 4 and the entire glasses.

Referring to FIGS. 1 and 2, the blink control device 200 may comprise a blink detection unit 5, a comparison unit and a control unit. The blink detection unit 5 may be configured to detect blinking behavior of a user and calculate a blinking frequency. The comparison unit may be configured to compare the blinking frequency detected by the blink detection unit 5 with a preset threshold and transmit a comparison result to the control unit. The control unit may be configured to, when it is determined that the blinking frequency is lower than the preset threshold, send a focus adjustment control signal to the drive mechanism 4. In an embodiment, the comparison and control units may be, for example, two separate modules integrated in one microchip 9, which is embedded in the frame 2 of the glasses. The blink detection unit 5 may be a miniature camera or myoelectric sensor, for example, for identifying and detecting blinking behavior of human eyes. Generally, normal human blinking frequency is within a certain interval. After a long period of work, eyes of individuals may blink at a reduced blinking frequency and then feel dry and painful. So, adjusting the blinking frequency of the individuals in time is necessary for their eye health. With the glasses of the present disclosure, it is possible to detect the blinking behavior of a user and then determine whether his or her blinking frequency during a time period is within a reasonable range, and in the case that the blinking frequency is too low, the user can be enabled to blink his or her eyes unconsciously. As such, the eyes of the user can be protected.

In a preferred embodiment, the blink control device 200 may further comprise a light supplementing module 6. The light supplementing module 6 may comprise an LED light source arranged beside the miniature camera in the frame. The light supplementing module may be configured to supplement ambient light in the case that image noise is generated due to insufficient ambient light, when the miniature camera captures an eye image of a user.

In a preferred embodiment, the glasses may further comprise a Bluetooth communication module 7, which is configured to connect to and communicate with a smart terminal. The smart terminal may provide a display interface and an input interface. The display interface may be configured to display a current working state of the glasses. The input interface may be configured to provide indications of user input. The current working state may include the current energy of the glasses, wearing time of the glasses, the current blinking frequency of a user, and the like. The user input may include a preset value of the blinking frequency, an input indicating whether or not the focal length needs to be switched, a time for switching the focal length, and a maintaining time.

In an embodiment, the glasses may further comprise a delay module 8, which may be configured to delay the focus adjustment control signal for a first delay period such that when the drive mechanism 4 receives the focus adjustment control signal, the lens assembly 1 is caused to be switched from the first focal length to the second focal length after the first delay period. In a particular embodiment, the first delay period may be from 1 to 2 seconds. In an embodiment, the delay module may be further configured to provide a delay of a second delay period such that the lens assembly 1 is caused to be switched back to the first focal length from the second focal length after the second delay period. If the lens assembly 1 is instantaneously switched to the second focal length from the first focal length, a blurred vision, produced instantaneously, will be provided to the user, and the user will perceive that such a blurred vision is caused by an intervention from the glasses. In contrast to this, when the switching process progresses relatively gradually and slowly, the user will get a blurred vision unconsciously. In this way, the degree of intervention from the glasses, that is perceived by a user, can be reduced, and the user experience can be enhanced. Similarly, if the lens assembly is not switched back to the first focal length after being switched to the second focal length, the user will perceive the intervention from the glasses when no vision change has occurred after blinking his or her eyes several times. So, the lens assembly should be switched back to the first focal length in time, so as to avoid bad user experience.

In an embodiment, the glasses may further comprise a switch module 10. The switch module 10 may comprise a first button and a second button that are disposed on the frame. The first button may be configured to control switching on and off of the glasses. The second button may be configured to control switching on and off of the light supplementing module 6.

The control chip 300 may be configured for controlling the blink control device or module 200, the focus adjustment module 100, the power supply module 3, the communication module 7, the delay module 8, and the switch module 10.

The present disclosure has been described with reference to preferred embodiments. It should be understood by those skilled in the art that various modifications, additions and substitutions are possible without departing from the scope and spirit of the disclosure.

What is claimed is:

1. Smart glasses with an eye protection function, configured to be adjustable in focal length when eyes of a user feel fatigue and to provide a blurred vision for the user of the glasses, so that the user will blink his or her eyes unconsciously; the glasses having a first focal length, which enables a clear vision to be provided to the user, and a second focal length, which is different from the first focal length and enables a blurred vision to be provided to the user; and, the glasses comprising:
an adjustable focus liquid lens assembly, comprising:
a first lens;
a second lens; and
a transparent liquid-filled flexible film sandwiched between the first lens and the second lens;
wherein, a focal length of the lens assembly is determined by the first lens, the second lens, and the flexible film together, and a focal length of the flexible film changes as a thickness of the flexible film changes; and
a drive mechanism, configured to drive the flexible film to deform and thus enable the thickness of the flexible film to be changed such that the focal length of the lens assembly is switched between the first focal length and the second focal length.

2. The glasses of claim 1, wherein, the first lens is one of a lens for myopia, a lens for presbyopia, and a plano lens that has no visual correcting power, and the second lens is a plano lens that has no visual correcting power; and wherein, the flexible film is attached to the second lens.

3. The glasses of claim 1, wherein, the drive mechanism comprises:
a piezoelectric ceramic element, configured to act on the flexible film; and
a drive circuit, configured to provide a driving voltage to the piezoelectric ceramic element such that the piezoelectric ceramic element is deformed under the action of the driving voltage and the flexible film is caused to change in thickness, allowing the lens assembly to be switched between the first focal length and the second focal length.

4. The glasses of claim 3, wherein, the drive mechanism further comprises a film holder configured to hold one end of the flexible film, wherein, the piezoelectric ceramic element is configured to directly cover the film holder, so that the deformation of the piezoelectric ceramic element can cause displacement of the film holder and in the case that the film holder is displaced, the flexible film is drawn by the film holder to deform, thereby allowing the lens assembly to be switched between the first focal length and the second focal length.

5. The glasses of claim 4, wherein, the piezoelectric ceramic element and the film holder are disposed in a frame of the glasses.

6. The glasses of claim 3, wherein, the first focal length is a focal length provided by the lens assembly when the driving voltage is zero, and the second focal length is a focal length provided by the lens assembly after deformation of the flexible film under the condition that the driving voltage is not zero.

7. The glasses of claim 1, further comprising a power supply module, configured to electrically connect to the drive mechanism for supplying power to the drive mechanism and the entire glasses.

8. The glasses of claim 1, further comprising a blink control device, which comprises:
a blink detection unit, configured to detect blinking behavior of a user and calculate a blinking frequency;
a comparison unit, configured to compare the blinking frequency detected by the blink detection unit with a preset threshold and transmit a comparison result to a control unit; and
the control unit, configured to, when it is determined that the blinking frequency is lower than the preset threshold, send a focus adjustment control signal to the drive mechanism.

9. The glasses of claim 8, further comprising a delay module, configured to delay the focus adjustment control signal for a first delay period such that when the drive mechanism receives the focus adjustment control signal, the lens assembly is caused to be switched from the first focal length to the second focal length after the first delay period.

10. The glasses of claim 9, wherein, the delay module is further configured to provide a delay of a second delay period such that the lens assembly is caused to be switched back to the first focal length from the second focal length after the second delay period.
